(19) United States
(12) Patent Application Publication
(10) Pub. No.: US 2007/0277882 A1
(43) Pub. Date: Dec. 6, 2007

(54) Float type drain trap

(76) Inventors: Tetsuo Oshima, Kanagawa (JP); Hiroshi Fukuhara, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/447,136

(22) Filed: Jun. 6, 2006

(51) Int. Cl. F16K 17/42

(52) U.S. Cl. 137/397

(57) ABSTRACT

Provided is a float type drain trap improved in terms of opening and closing of a valve seat. In the prior art, the valve seat is opened and closed mainly by a self-weight of a float and buoyancy of a float main body, so the valve seat is often left in a half-open state, with opening and closing of the valve seat being rather equivocal. Afloat is accommodated in a case, and drain water allowed to flow into the case is enabled to be discharged by buoyancy acting on the float. By providing a magnet between the case and the float, an attraction force is generated, and an outlet port formed in the case is closed or opened based on the relationship between the buoyancy, the attraction force, and the positions where these forces are generated, thereby making it possible to retain and discharge the drain water.

### BACKGROUND OF THE INVENTION

1. Field of the Invention

The present invention relates to a technique related to a float type drain trap, and more specifically, to a technique for discharging drain water accumulated in a drain trap by mainly utilizing a buoyancy and an attraction force of a magnet.

2. Description of the Related Art

In a conventional technique related to a method of discharging drain water and a float type drain trap, there is a case where a float 200A is accommodated in a case 100A.

In the following, a method of discharging drain water and a float type drain trap according to the conventional technique will be described with reference to FIG. 5. In the drawing, reference symbol 100A indicates a case, which is formed as an integral unit composed of a case main body 50, a float bracket 7, a valve seat 9, and a manual valve 4 having an O-ring. The case main body 50 is formed as an integral unit composed of a first case 1, a second case 2, and a gasket 3, and is perfectly sealed to prevent leakage of drain water except for an inlet port 50a and an outlet port 50b which are formed in the case main body 50.

Reference symbol 200A denotes a float, which is formed as an integral unit composed of a float main body 5, an arm 6, and a rubber valve seat 8. In this case, the arm 6 is formed in a substantially L-shaped configuration, and has at one end thereof the float main body 5 for generating a buoyancy when drain water allowed to flow in through the inlet port 50a formed in the case 100A has been accumulated to a certain degree. The arm 6 has at the other end thereof the rubber valve seat 8 for opening and closing the valve seat 9 situated in the outlet port 50b formed in the case 100A. Further, the arm 6 has at a bent portion thereof a rotation shaft 6a, which is engaged with the float bracket 7 formed in the case 100A, thereby making the entire float 200A rotatable.

Thus, when not much drain water has been flowed into the case 100A yet, no buoyancy is applied to the float main body 5, and the rubber valve seat 8 is held in intimate contact with the valve seat 9 by the self-weight of the float 200A to keep the case in the closed state. When a lot of drain water has flowed into the case 100A to attain a level not lower than a fixed position, the buoyancy is applied to the float main body 5, and due to the buoyancy, the rubber valve seat 8 is separated from the valve seat 9 to bring the case into the open state. It should be noted, however, that due to the pressure of compressed air caused to flow into the case 100A, the force acting on the valve seat 9 and the elastic force of the rubber valve seat 8 also influence the opening and closing of the valve seat 9.

The conventional method of discharging drain water and the conventional float type drain trap described above have the following problem.

Since the opening and closing of the valve seat is effected mainly by virtue of the self-weight of the float and the buoyancy due to the float main body, the valve seat is often left in a half-opened state, the opening and closing of the valve seat being rather equivocal.

### SUMMARY OF THE INVENTION

To solve the above-mentioned problem, the present invention employs the following structures. A float type drain trap of the present invention is characterized by including a float formed as an integral unit having: an arm; a float main body provided at one end of the arm and capable of floating in water; a rubber valve seat provided at the other end of the arm; and a rotation shaft provided at a middle bent portion of the arm. Also, the float type drain trap of the present invention is characterized by including a case formed as an integral unit having: a case main body equipped with an inlet port through which drain water flows in and an outlet port through which drain water flows out; a valve seat situated in the outlet port; and a float bracket for retaining the rotation shaft to thereby make the float rotatable. In the float type drain trap, the rotation shaft is situated on the float bracket inside the case so that, when drain water has not flowed in to attain a fixed position inside the case, the rubber valve seat closes the valve seat by the self-weight of the float, and when drain water has flowed in to attain the fixed position inside the case, the rubber valve seat opens the valve seat by the buoyancy of the float main body. Further, the float type drain trap is characterized in that a magnet is arranged at some position on the arm between the float main body and the rotation shaft, and in that associated members causing an attraction force due to the magnet to be generated are arranged at some position inside the case. Still further, the float type drain trap is characterized in that the rubber valve seat closes or opens the valve seat based on moments as defined by the self-weight of the float, the buoyancy, the attraction force, and the positions where these forces are generated. Yet further, the float type drain trap is characterized in that the associated members are composed of a plate spring and a plate spring bracket supporting the plate spring at some position inside the case. Furthermore, the float type drain trap is characterized in that the plate spring bracket constitutes a constraining means for retaining the position of the plate spring when the plate spring is separated from the magnet.

As is apparent from the above description, the present invention provides the following effects.

First, by providing a float with a magnet, and by providing a case with a plate spring and a spring bracket for supporting the spring plate at some position inside the case, with the plate spring and the spring bracket constituting associated members, it is possible to prevent fine movements with respect to the opening and closing, thereby preventing occurrence of a half-open state.

Second, due to the provision of the plate spring, it is possible to markedly prevent occurrence of a half-open state.

Third, due to the provision of the plate spring bracket as a constraining means, it is possible to prevent, still more markedly, occurrence of a half-open state.

### BRIEF DESCRIPTION OF THE DRAWINGS

In the accompanying drawings:

FIG. 1 is a schematic view of a float type drain trap according to the present invention with the outlet port thereof closed;

FIG. 2 is a schematic view of a float type drain trap according to the present invention with the outlet port thereof open;

FIG. 3 is an explanatory view illustrating the relationship between the forces acting on a float constituting the float type drain trap of the present invention;

FIG. 4 is a perspective view of an arm and a rubber valve seat according to the present invention; and

FIG. 5 is a schematic view of a conventional float type drain trap with the outlet port thereof open.

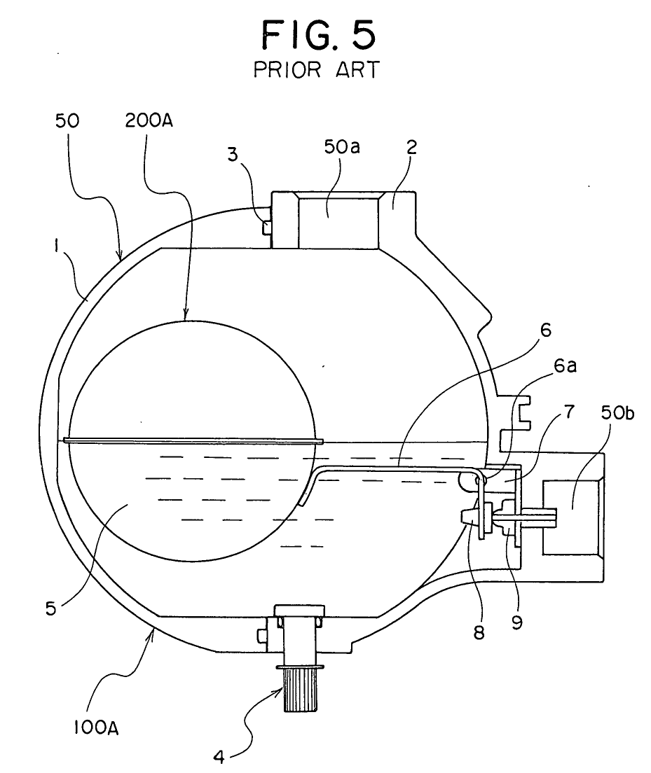

### DETAILED DESCRIPTION OF THE PREFERRED EMBODIMENT

In the following, an embodiment of the present invention will be described in detail with reference to the drawings.

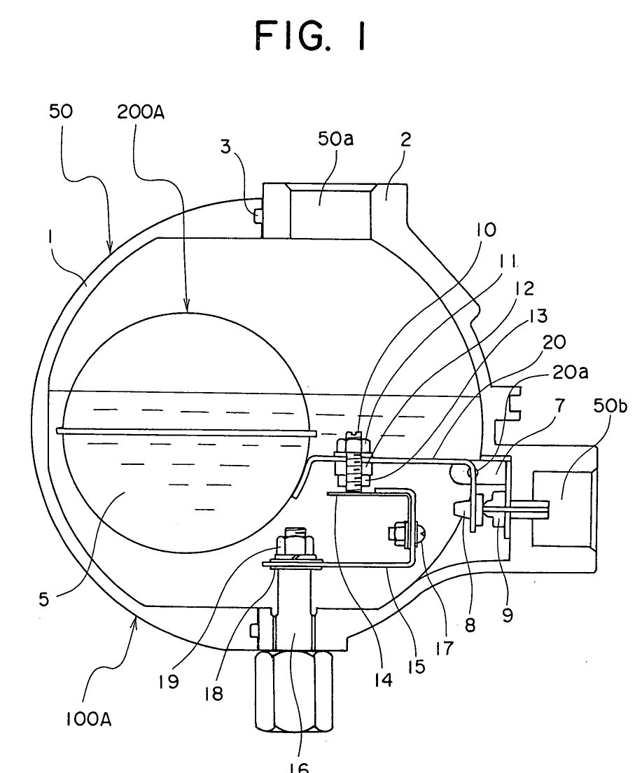

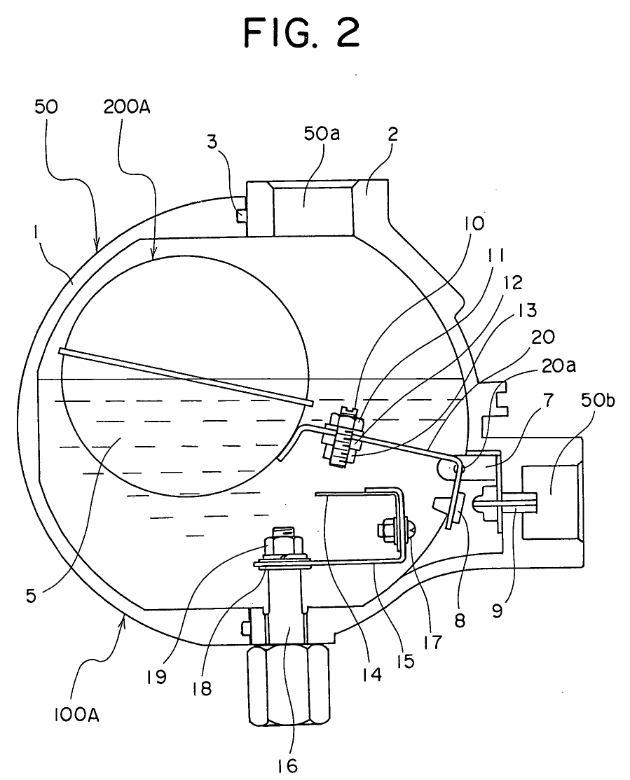

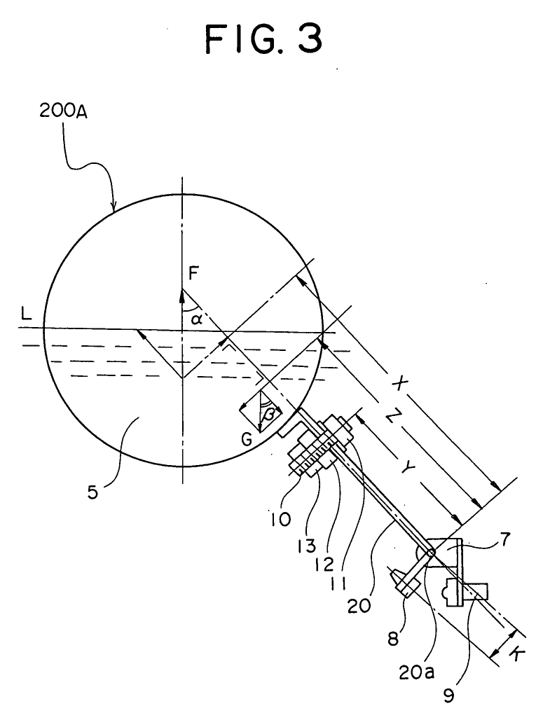

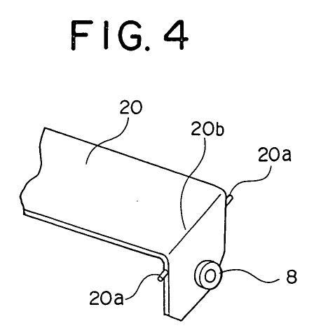

Here, FIG. 1 is a diagram showing a float type drain trap according to the present invention with the outlet port thereof closed, FIG. 2 is a diagram showing a float type drain trap according to the present invention with the outlet port thereof open, FIG. 3 is a diagram illustrating the relationship between the forces acting on the float constituting the float type drain trap of the present invention, and FIG. 4 is a diagram showing an arm and a rubber valve seat according to the present invention.

As shown in FIGS. 1, 2, and 3, reference symbol 100A denotes a case, which is formed as an integral unit composed of a case main body 50, a float bracket 7, a valve seat 9, a stay 16, a washer 18, a nut 19, a plate spring bracket 15, a fixing screw 17, and a plate spring 14. The case main body 50 is formed as an integral unit composed of a first case 1, a second case 2, and a gasket 3, and is perfectly sealed to prevent leakage of drain water except for an inlet port 50a and an outlet port 50b which are formed in the case main body 50.

Reference symbol 200A denotes a float, which is formed as an integral unit composed of a hollow float main body 5, an arm 20, an adjustment screw 10, a nut 11, a magnet seat 12, a magnet 13, and a rubber valve seat 8. In this example, the arm 20 has a substantially L-shaped configuration, and has at one end thereof the float main body 5, which generates buoyancy F when drain water allowed to flow in through the inlet port 50a formed in the case 100A has been accumulated to a certain degree. The arm 20 has at the other end thereof the rubber valve seat 8 for opening and closing the valve seat 9 situated in the outlet port 50b formed in the case 100A. The arm 20 has at a bent portion 20b thereof a rotation shaft 20a engaged with the float bracket 7 formed in the case 100A, thereby making the entire float 200A rotatable. As shown in FIG. 4, the rotation shaft 20a protrudes from both sides of the bent portion 20b.

It should be noted, however, that the configuration of the arm 20 is not restricted to the substantially L-shaped one; it may also be a substantially U-shaped one, etc. The angle of the bent portion 20b of the arm 20 may be 90° or more, or 90° or less. In addition, when the rubber valve seat 8 keeps the valve seat 9 in the closed state, the arm 20 may extend parallel to the water surface L; however, the arm 20 may extend so as not to be parallel to the water surface. Further, the arm 20 may also be formed as a flat plate of a substantially I-shaped configuration. Further, instead of being situated coaxially, the rubber valve seat 8 and the valve seat 9 may be situated so as to be perpendicular to each other.

When drain water flows into or out of the case 100A, the entire float 200A rotates around the rotation shaft 20a, thereby enabling the rubber valve seat 8 to open and close the valve seat 9.

The arm 20, which constitutes the float 200A, has, in the portion thereof between the float main body 5 and the rotation shaft 20a, the adjustment screw 10, the nut 11, the magnet seat 12, and the magnet 13, which are arranged so as to be integral with the arm 20.

In particular, the nut 11 and the magnet seat 12 are situated with the arm 20 therebetween, and these three components are fixed together through threaded engagement using the adjustment screw 10, and the magnet 13 and the magnet seat 12 are fixed together by an absorption of the magnetic force. Further, the adjustment screw 10 serves to adjust the distance between the magnet 13 and the plate spring 14.

The plate spring 14 has a substantially L-shaped configuration, and is fixed to the J-shaped plate spring bracket 15 by a fixing screw 17. The plate spring bracket 15 is fixed to the stay 16 by the washer 18 and the nut 19. The stay 16 is fixed to the lower portion of the case main body 50 through threaded engagement.

It should be noted, however, that the configuration of the plate spring 14 is not restricted to the substantially L-shaped one. It may also be formed as a flat plate of a substantially I-shaped configuration or some other configuration. Further, also regarding the configuration of the plate spring bracket 15, it need not be restricted to the substantially J-shaped one. It may also be of a substantially L-shaped configuration or some other configuration.

Here, when the plate spring 14 is attracted by the magnetic force of the magnet 13, the plate spring bracket 15 also serves as a constraining means, which prevents the right-angle portion of the substantially L-shaped plate spring 14 from assuming an angle equal to or larger than 90 degrees due to the attraction by the magnetic force.

In the following, the operation of the method of discharging drain water and the float type drain trap of the present invention, constructed as described above, will be illustrated.

First, drain water flows into the case 100A through the inlet port 50a. When no or little drain water has flowed into the case 100A, the rubber valve seat 8 and the valve seat 9 are held in intimate contact with each other to be closed by means of the arm 20 rotatable around the rotation shaft 20a formed at the bent portion 20b of the arm 20 by a force mainly attributable to the self-weight of the float 200A and to the attraction force of the magnet 13. In this case, the water surface L is as shown in FIG. 3, which also applies to FIGS. 1 and 2.

As the amount of drain water in the case 100A increases, a buoyancy F is generated to a degree corresponding to the amount of drain water displaced by the hollow float main body 5. This will be illustrated with reference to FIG. 3. Since the float main body 5 is a sphere, the buoyancy F is applied upwardly toward the center of the sphere. In contrast, the self-weight G of the float 200A as a whole is exerted downwardly.

The following equation 1 holds true mainly based on the attraction force exerted between the magnet 13 attached to the arm 20 and the plate spring 14 attached to the case 100A.

M=(the buoyancy F of the float main body 5)×Sin α×X−(the self-weight G of the float 200A)×Sin β×Z−(the attraction force of the magnet 13)×Y+(the elastic force of the rubber valve seat 8)×K−(the sectional are a of the flow path of the valve seat 9)×(the compressed air pressure)×K, [Equation 1]

where X: the minimum distance between the rotation shaft 20a and the center of the buoyancy F of the float main body 5 as measured along the arm 20 or an extension thereof;

Y: the distance between the rotation shaft 20a and the center of the magnet 13 on the arm 20;

Z: the minimum distance between the rotation shaft 20a and the center of the self-weight G of the float 200A as measured along the arm 20 or an extension thereof;

K: the distance between the rotation shaft 20a and the center of the rubber valve seat 8 on the arm 20;

α: the angle made by the vertical line along which the buoyancy is generated and the arm; and

β: the angle made by the vertical line along which the self-weight is generated and the arm. Here, it is actually possible for the buoyancy F, the self-weight G, and the arm 20 to be in the same plane. In this case, α=β is established.

Thus, when the value of M is negative, the rubber valve seat 8 closes the valve seat 9, and when the value of M is positive, the rubber valve seat 8 opens the valve seat 9. That is, the above-mentioned condition can be satisfied in various ways through appropriate settings of the magnitude of the buoyancy F of the float main body 5, the strength of the attraction force of the magnet 13, the self-weight G of the float 200A, the diameter of the flow path of the valve seat 9, the compressed air pressure, and the distances X, Y, Z, and K between the rotation shaft 20a and the positions where the above-mentioned forces are exerted. That is, the buoyancy F varies depending on the amount of drain water, and the self-weight G of the float 200A varies depending on the inclination of the arm 20, which results from the buoyancy.

In this way, through the provision of the attraction force due to the magnet 13 and through the provision of the plate spring 14, it is possible for the rubber valve seat 8 to open or close the valve seat 9 instantaneously. Further, it is possible to prevent the valve seat 9 from being placed in a half-open state.

To constrain the plate spring 14, there is provided the plate spring bracket 15 as the constraining means, thereby constraining the plate spring 14 so as not to be easily bent upwardly.

The above description of the present invention should not be construed restrictively. It is also possible for the magnet 13 to be arranged to be connected to the rubber valve seat 8 for opening and closing the valve seat 9 situated in the outlet port 50b formed in the case main body 50, thereby directly contributing to the opening and closing. It is also possible to connect the float main body 5 and the magnet 13 by a chain, a wire, etc., and when the buoyancy is applied to the float main body 5, the attraction force of the magnet 13 is overcome. Thus, the position of the rubber valve seat 8 is directly shifted, thereby opening the valve seat 9. In this case, the magnet 13 and the rubber valve seat 8 may be integrated with each other.

Further, said rubber valve seat 8 is composed of a rubber, however it is able to make said valve seat 8 by a resin, metal and so on.

What is claimed is:

1. A float type drain trap, comprising:
a float (200A) formed as an integral unit having an arm (20), a float main body (5) provided at one end of the arm (20) and capable of floating in water, a valve seat (8) provided at the other end of the arm (20), and a rotation shaft (20a) provided at a middle bent portion of the arm (20); and
a case (100A) formed as an integral unit having a case main body (50) equipped with an inlet port (50a) through which drain water flows in and an outlet port (50b) through which drain water flows out, a valve seat (9) situated in the outlet port (50b), and a float bracket (7) for retaining the rotation shaft (20a) to thereby make the float (200A) rotatable,
the rotation shaft (20a) being situated on the float bracket (7) inside the case (100A) so that, when drain water has not flowed in to attain a fixed position inside the case (100A), the valve seat (8) closes the valve seat (9) by the self-weight (G) of the float (200A), and when drain water has flowed in to attain the fixed position inside the case (100A), the valve seat (8) opens the valve seat (9) by the buoyancy (F) of the float main body (5),
wherein a magnet (13) is arranged at some position on the arm (20) between the float main body (5) and the rotation shaft (20a), and
wherein associated members (14, 15) causing an attraction force due to the magnet (13) to be generated are arranged at some position inside the case (100A).

2. A float type drain trap according to claim 1, wherein the valve seat (8) closes or opens the valve seat (9) based on moments as defined by the self-weight (G) of the float (200A), the buoyancy (F), the attraction force, and the positions (Z, X, Y) where these forces are generated.

3. A float type drain trap according to claim 1, wherein the associated members (14, 15) are composed of a plate spring (14) and a plate spring bracket (15) for supporting the plate spring (14) at some position inside the case (100A).

4. A float type drain trap according to claim 2, wherein the associated members (14, 15) are composed of a plate spring (14) and a plate spring bracket (15) for supporting the plate spring (14) at some position inside the case (100A).

5. A float type drain trap according to claim 3, wherein the plate spring bracket (15) constitutes a constraining means for retaining the position of the plate spring (14) when the plate spring (14) is separated from the magnet (13).
